(19) United States
(12) Patent Application Publication
(10) Pub. No.: US 2003/0065538 A1
(43) Pub. Date: Apr. 3, 2003

(54) Patient information system for explaining medical findings

(76) Inventors: Klaus Abraham-Fuchs, Erlangen (DE); Johannes Bieger, Munchen (DE); Arne Hengerer, Erlangen (DE); Eva Rumpel, Erlangen (DE); Daniel Tietze, Spardorf (DE)

Correspondence Address: YOUNG & THOMPSON, 745 SOUTH 23RD STREET 2ND FLOOR, ARLINGTON, VA, 22202

(21) Appl. No.: 10/231,236

(22) Filed: Aug. 30, 2002

(30) Foreign Application Priority Data
Aug. 30, 2001 (DE) 10142341.1

(51) Int. Cl. G06F 17/60

(52) U.S. Cl. 705/3

(57) ABSTRACT

A patient information system for the patient-oriented interactive explanation of medical findings, includes an expert system with an input device accessible to the patient and that interprets and explains the information contained in medical findings which are input on the basis of a rule mechanism stored in the system in accordance with input individual information about the patient. The system converts the findings, which are incomprehensible as a result of specialist medical expressions, into more comprehensible everyday language containing more extensive explanations of the specialist medical expressions.

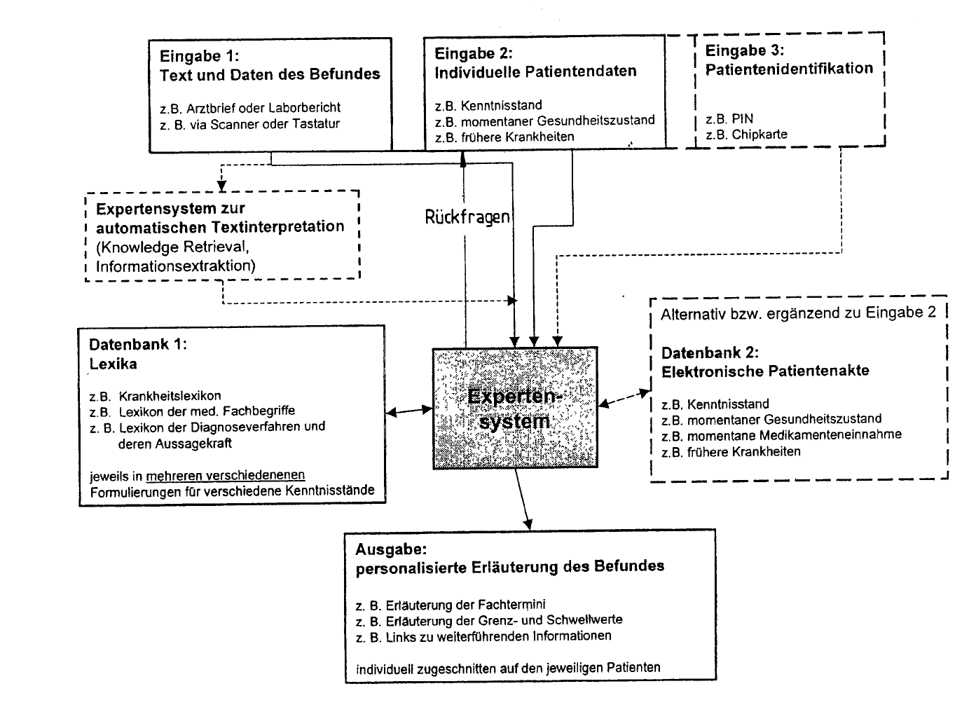

### BACKGROUND OF THE INVENTION

The invention relates to a patient system for the patient-oriented, interactive explanation of medical findings.

Whether occasioned by an acute illness or by a precautionary measure, measurements and examinations are carried out on a patient, their results are documented in the medical findings and form the basis for the diagnosis and subsequent treatment. Upon request or else routinely (private patients), patients are given a copy of their findings, such as the blood values or medical findings, be they in the form of a laboratory report or as a copy of a doctor's letter. However, these documents are often barely comprehensible to a medical layman and there is normally insufficient time for a thorough explanation by the doctor. This situation is very unsatisfactory for many patients, since they would like to be better informed about the results of the examination and their consequences. However, since an informed patient is also a motivated patient, doctors, but also insurance providers, at this point often throw away any chance of achieving greater compliance by improved inclusion and enlightenment of the patients.

Hitherto, interested patients were advised to inform themselves by means of printed media, such as reference works, popular scientific publications and introductory specialist literature. However, this information is kept general and it requires a great deal of time and trouble to filter out the information that is relevant to the individual case. In recent times, several service providers have offered a service in which medical personnel respond to patient questions via e-mail or on the telephone. However, this method requires a large number of personnel and is correspondingly expensive and, ultimately, represents no improvement at all as compared with expensive, extensive information from the treating doctor. However, provisions at moderate prices, such as are already offered via e-mail, do not go further into the personal qualifications of the patient, such as his or her level of education, an additional factor also always being that off-line research is associated with a time delay.

DE 690 30 664 T2 has already disclosed an expert system, but this concerns computer-aided diagnosis, that is to say the system is intended to be able to detect and diagnose possible causal illnesses on the basis of inputs relating to the condition of the patient. The problem posed in the course of this application, however, does not lie in compiling a diagnosis but in the interpretation of a diagnosis which has already been made and which, as a result of its relatively incomprehensible medical findings formulation, is not comprehensible to a patient.

The same also applies to a method and an apparatus for on-line interpretation of medical data corresponding to DE 100 65 580 A1. What is concerned here is the preparation of medical data, again for the purposes of computer-aided diagnosis, but not for the interpretation of a medical finding that is incomprehensible to a layman.

### SUMMARY OF THE INVENTION

The invention is therefore based on the object of creating a patient information system for the patient-oriented interactive explanation of medical findings which draws up interpretations and explanations relating to medical findings which are matched individually to the patient, and also specifically to his level of previous knowledge.

### BRIEF DESCRIPTION OF THE DRAWING

The drawing is a schematic diagram illustrating an embodiment of the present invention.

### DESCRIPTION OF PREFERRED EMBODIMENT

In order to achieve the objects of the present invention, the invention provides an expert system which is provided with an input device accessible to the patient and which interprets and explains the information contained in medical findings which are input on the basis of a rule mechanism stored in it, in accordance with likewise input individual information about the patient, e.g. the level of previous education and the understanding of language or the medical history of the patient, in particular converts the findings, which are incomprehensible as a result of specialist medical expressions, into more comprehensible everyday language containing more extensive explanations.

In this case, the input device is a keyboard in the simplest case, or, preferably also in addition thereto, a scanner in order for example to be able to read in a doctor's letter or laboratory report directly and without cumbersome input into the keyboard. If the findings are already present in digitized form, they can also be put into the expert system directly—for example via a link—or requested by said system.

In the simplest case, in addition to the findings, the patient additionally inputs individual patient data, such as his state of knowledge, current state of health or earlier illnesses. In order precisely to be able to acquire this individual patient data, the expert system is preferably provided with automatic access to the input device, in order to place interpretation-relevant queries as required. Therefore, following the input of the findings, a small list of questions can be sent back to the input device by the expert system, the list having to be processed by the patient in order that the expert system can specifically interrogate the individual patient data specially mentioned above.

In a development of the invention, the expert system is to have access to a central or decentral electronic patient record, in which this individual patient data is largely already contained, so that repeated input by the patient making the query is not necessary at all. Particularly in this case, however, the input device expediently has to be provided with a patient identification system secured by means of a PIN, smart card or the like, in order that the authorization and the access authorization of the patient raising the question to his electronic patient record is secured. In this case, the expert system does not need to have directly stored all the information necessary to explain and interpret a finding, instead it is sufficient if, in addition to a fundamental interpretation rule mechanism, it is connected to lexical databases, such as an encyclopedia of diseases, an encyclopedia of specialist medical terms, an encyclopedia of diagnostic methods and their meaningfulness or the like.

If the initial data, that is to say the findings data which is input via the input device, is not highly structured data material, such as laboratory values or findings based on the text modules or a doctor's letter, but free-flowing text, then text interpretation has to be carried out first. For this purpose, a special text interpretation system, preferably integrated into the expert system, is provided according to the invention for preparing unstructured findings.

The decision as to which questions have to be posed to the patient is made by the expert system on the basis of the rule mechanism stored in it. The incoming data puts the expert system into the position of classifying the requirement of the user for knowledge and therefore providing individually tailored information.

As a result, the expert system then supplies the user with a textual interpretation, matched to his level of language, of the laboratory values, of the findings or doctor's letter and any useful background information, such as the explanation of the specialist terms, explanation of the limiting and threshold values, advantages and disadvantages of alternative treatments, links to further-reaching information such as self-help groups and second opinions, etc.

With reference now to the drawing, an expert system with a rule mechanism stored therein for the interpretation of medical findings is connected to an input device, by means of which the patient can first of all input the text and the data from the findings into the expert system via an input device. For this purpose, either a scanner or a keyboard can be provided, for example the patient selecting the suitable form via the Internet, for example in order to input a blood test and its results, and entering the values ascertained by him into this form.

In addition, as an input, the individual patient data can be input, for example his or her level of knowledge, the current state of health or earlier illnesses, this input of individual patient data preferably being carried out in a direct feedback loop with the expert system, which makes the decision as to which of these specified items of individual patient data it needs specifically for its interpretation of the medical findings. The expert system therefore raises questions at the input device, and the patient provides the appropriate explanations.

The expert system is connected to a database, which can contain a large number of different medical encyclopedias, such as an encyclopedia of diseases, an encyclopedia of specialist medical terms, an encyclopedia of diagnostic methods and their meaningfulness, as a result of which, inter alia, for each term in the findings, a plurality of different formulations for different levels of knowledge are available, which the expert system can then utilize on the basis of the individual patient data with the effect that during the output, namely the personalized explanation of the findings, it can also consider this individual patient data, specifically the level of knowledge of said patient. This is because if the expert system knows that the patient raising the question is a layman with basic school education, then it can select quite different terms for the explanation and, in particular, also explain specialist terms specifically which it would not explain if it realizes that the patient raising the question has a certain medical background or some other higher level of education.

The expert system is particularly advantageously connected to a second database which contains a central or decentral electronic patient record. In said record, all the individual patient data, which otherwise would have to be input by the patient him- or herself via the input of the individual patient data, is already present and frequently even in a substantially more detailed form. In particular, this frequently saves the patient from embarrassing queries about his or her level of education or the like, since this is certainly already noted in the electronic patient record.

In particular when the expert system is connected to the electronic patient record or can refer back to the latter, a patient identification system is required in the input device, which is secured via a PIN number or a smart card, a fingerprint or retina detection system or the like, so that it is ensured that the patient raising the question is also actually the one whose electronic patient record is to be evaluated by the expert system at the same time.

In the case of inputting the blood test mentioned at the beginning as a medical finding to be interpreted, and the level of education of the user determined specifically from the patient database (for example: there is an understanding of biological relationships), and in circumstances to be taken particularly into account (user is diabetic), the system can ultimately supply the patient with individually adapted information inter alia about the meaningfulness of the individual blood parameters, the associated threshold values, the doubt associated with the values measured in this case, the possible treatments and address and literature references as output.

In cases in which the findings or doctor's letter are/is not structured in the same way as in the case of data from a blood count, that is to say, for example, if the findings are free-flowing text, a text interpretation program for preparing these unstructured findings can additionally be provided, this text interpretation program which, in the FIGURE, is designated an expert system for automatic text interpretation, preferably being incorporated directly into the expert system. It is precisely in this case that the possibility of the expert system posing queries to the patient making the input is meaningful, since a finding may, for example, speak of a tumor of classification 17, which is initially also not entirely clear to the explanatory expert system. In order to provide security here as well, the expert system can ask the patient whether cancer has been diagnosed in his or her case, and, depending whether the patient answers with yes or no, the tumor classification is to be presented in a different manner.

1. A patient information system for the patient-oriented interactive explanation of medical findings, comprising:
an expert system with an input device accessible to a patient and that interprets and explains information contained in medical findings which are input to said expert system on the basis of a rule mechanism stored in said expert system and in accordance with input individual information about the patient, said expert system converting the medical findings that are incomprehensible to the patient as a result of specialist medical expressions into language containing explanations of the specialist medical expressions comprehensible to the patient.

2. The patient information system as claimed in claim 1, wherein the individual information comprises at least one a level of the patient's education, an indication of the patient's understanding of language, and a medical history of the patient.

3. The patient information system as claimed in claim 1 wherin the input device comprises one of a keyboard and a scanner.

4. The patient information system as claimed in claim 1, wherein the input device contains a secure patient identification system.

5. The patient information system as claimed in claim 1, wherein the expert system has automatic access to the input device in order to place interpretation-relevant queries.

6. The patient information system as claimed in claim 1, wherein the expert system has access to an electronic patient record.

7. The patient information system as claimed in claim 1, wherein the expert system is connected to lexical databases comprising an encyclopedia of diseases, an encyclopedia of specialist medical terms, and an encyclopedia of diagnostic methods.

8. The patient information system as claimed in claim 1, further comprising a text interpretation system integrated into the expert system for preparing unstructured findings.
